(19) United States
(12) Patent Application Publication
(10) Pub. No.: US 2023/0376616 A1
(43) Pub. Date: Nov. 23, 2023

(54) METHODS AND SYSTEMS FOR DATA ACCESS MANAGEMENT AND DATA ENTITLEMENTS INTEGRATION

(71) Applicant: KOHLBERG KRAVIS ROBERTS & CO. L.P., New York, NY (US)

(72) Inventors: Emil WERR, Wayne, NJ (US); Daniel SANDHOLDT, Kalispell, MT (US); Xiaocong LIU, Dix Hills, NY (US); Rafid A. ZANE, Kendall Park, NJ (US)

(73) Assignee: KOHLBERG KRAVIS ROBERTS & CO. L.P., New York, NY (US)

(21) Appl. No.: 17/747,071

(22) Filed: May 18, 2022

(51) Int. Cl. G06F 21/60; G06F 21/62

(52) U.S. Cl. CPC G06F 21/604; G06F 21/6218

(57) ABSTRACT

A method, system, and computer program product for data access management. A processing device stores metadata defining user access permissions for a plurality digital content files located in a plurality of external data stores. The processing device may receive a user data request for one of the plurality of digital content files, identify an external data store containing the requested digital content file, and retrieve the requested digital content file. Retrieving the requested digital content file from the identified external data store may include translating the user data request into a native language of the external data store, generating an API call, transmitting the API call to the external data store, and receiving the digital content file from the external data store. The processing device may then transmit the requested data content file to the user of the received user data request.

### FIELD

The present disclosure relates to methods, systems, and computer program products for data access management and data entitlements integration. More particularly, the present disclosure relates to administering data entitlement in an organization irrespective of where organization data is stored.

### BACKGROUND

Organizations have data spread across tens, hundreds, or even thousands of databases and applications. Each data resource (i.e., RDBMS, File System, S3 storage, Rest API, etc.) requires some type of access control to manage who can see what data. Furthermore, data copies proliferate throughout these systems and the permissions to this data become out of sync very quickly. Security is generally bound to the data origination system and perhaps it is also manually updated in the downstream system where a copy of data is stored. The access control is used to permit or deny access to a data resource and objects. Synchronization of data entitlements in a federated data and heterogeneous technology ecosystem is very complex and costly. Each system will have a different data authorization (i.e., data security) model for authorizing access to data resources and objects. Thus, there is a need for a novel solution for administering data entitlement irrespective of where the data is stored.

### SUMMARY

A method for data access management is disclosed. The method includes storing, by a processing device in a structured metadata catalog, metadata for a plurality digital content files located in a plurality of external data stores, the metadata defining user access permissions for one or more users to the plurality of digital content files; receiving, by the processing device, a user data request from one of the one or more users for one of the plurality of digital content files; identifying, by the processing device, an external data store of the plurality of external data stores containing the requested digital content file; retrieving, by the processing device, the requested digital content file from the identified external data store, wherein the retrieving the requested digital content file includes: translating, by the processing device, the user data request into a native language of the identified external data store; generating, by the processing device, an application programming interface (API) call to the identified external data store, the API call including the metadata for the user of the received user data request; transmitting, by the processing device, the API call to the identified external data store; receiving, by the processing device, the requested digital content file from the identified external data store; and transmitting, by the processing device, the requested data content file to the user of the received user data request.

A system for data access management is disclosed. The system including one or more processors, one or more computer-readable memories, one or more computer-readable tangible storage devices, and instructions stored on at least one of the one or more storage devices for execution by at least one of the one or more processors via at least one of the one or more computer-readable memories, the instructions comprising: instructions to store in a structured metadata catalog, metadata for a plurality digital content files located in a plurality of external data stores, the metadata defining user access permissions for one or more users to the plurality of digital content files; instructions to receive a user data request from one of the one or more users for one of the plurality of digital content files; instructions to identify an external data store of the plurality of external data stores containing the requested digital content file; instructions to retrieve the requested digital content file from the identified external data store, wherein the retrieving the requested digital content file includes: instructions to translate the user data request into a native language of the identified external data store; instructions to generate an application programming interface (API) call to the identified external data store, the API call including the metadata for the user of the received user data request; instructions to transmit the API call to the identified external data store; instructions to receive the requested digital content file from the identified external data store; and instructions to transmit the requested data content file to the user of the received user data request.

A computer program product for data access management is disclosed. The computer program product including: a computer-readable storage medium having program instructions embodied therewith, the program instructions executable by a computer to cause the computer to perform a method, comprising: storing, by a processing device in a structured metadata catalog, metadata for a plurality digital content files located in a plurality of external data stores, the metadata defining user access permissions for one or more users to the plurality of digital content files; receiving, by the processing device, a user data request from one of the one or more users for one of the plurality of digital content files; identifying, by the processing device, an external data store of the plurality of external data stores containing the requested digital content file; retrieving, by the processing device, the requested digital content file from the identified external data store, wherein the retrieving the requested digital content file includes: translating, by the processing device, the user data request into a native language of the identified external data store; generating, by the processing device, an application programming interface (API) call to the identified external data store, the API call including the metadata for the user of the received user data request; transmitting, by the processing device, the API call to the identified external data store; receiving, by the processing device, the requested digital content file from the identified external data store; and transmitting, by the processing device, the requested data content file to the user of the received user data request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIGS. 1A-1B illustrates a high-level system architecture for data access management and data entitlements integration in accordance with exemplary embodiments;

FIGS. 2A-2B is a flow chart illustrating a process for data access management and data entitlements integration in accordance with exemplary embodiments;

FIG. 3 is a flowchart illustrating a method for data access management and data entitlements integration in accordance with exemplary embodiments; and

FIG. 4 is a block diagram illustrating a computer system architecture in accordance with exemplary embodiments.

### DETAILED DESCRIPTION

As discussed above, current methods and systems of data entitlements management in an organization require the management of many different data storage systems with different data authorization models. Exemplary embodiments of the methods and systems provided herein address the issues with the current methods and systems by implementing a single intelligent system that is used to administer data entitlements irrespective of where the data is stored. In particular, exemplary embodiments of the methods and systems automate CRUD (Create, Read, Update, Delete) transactions for all security events between the security administration portal that is centralized within an organization and the data storage systems that are distributed within an organization. A key feature of the methods and systems disclosed herein is that security is applied at the metadata level and then automatically replicated to the storage and/or rendering applications (i.e., interfaces), which permits an organization to maintain its data entitlements in one single repository and to update permissions in all the spokes (data platforms or applications) where data is served from. For example, an organization may include an entity called “Accounts” that contains account numbers and related data points stored in multiple platforms where applications and end-users may consume this data. To ensure security consistency across all these applications traditional approaches utilize database administrators who then go into the system and set the permissions for the accounts object, which leads to inconsistency and deficient data access control. In contrast exemplary embodiments of the methods and systems disclosed herein monitor the changes using a common metadata model (e.g., groups, roles, users, permissions, resources, objects, data elements, etc.) and orchestrate API calls to each of the systems containing the raw data. Thus, exemplary embodiments of the methods and systems provided herein provide a more efficient data access management and data entitlements integration.

System Overview for Data Access Management and Data Entitlements Integration

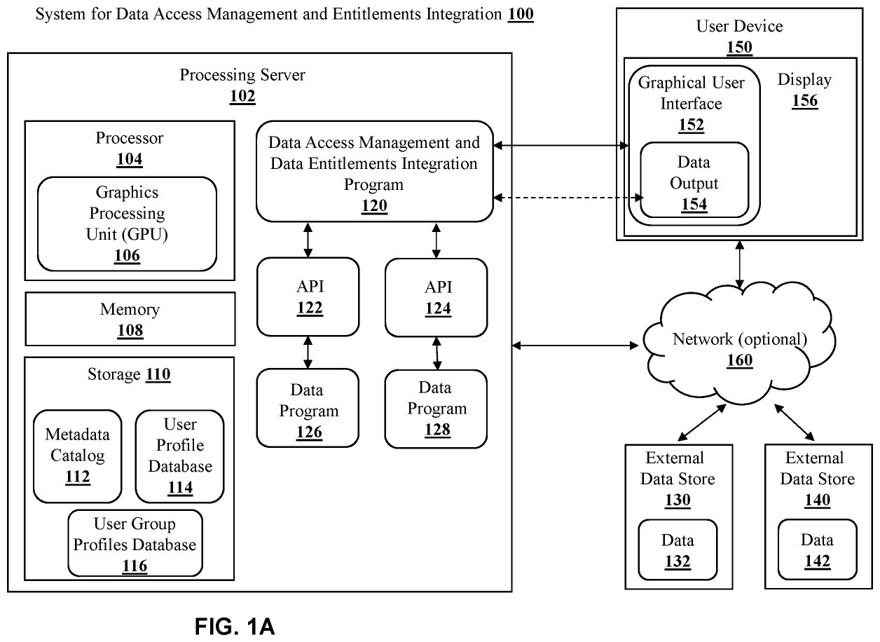

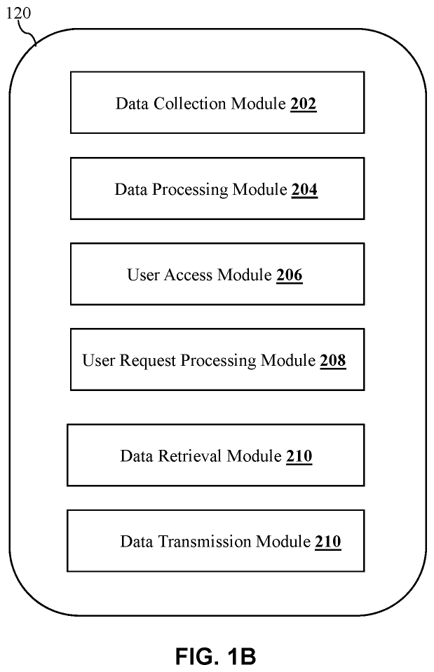

FIG. 1A illustrates system 100 for data access management and data entitlements integration in accordance with exemplary embodiments.

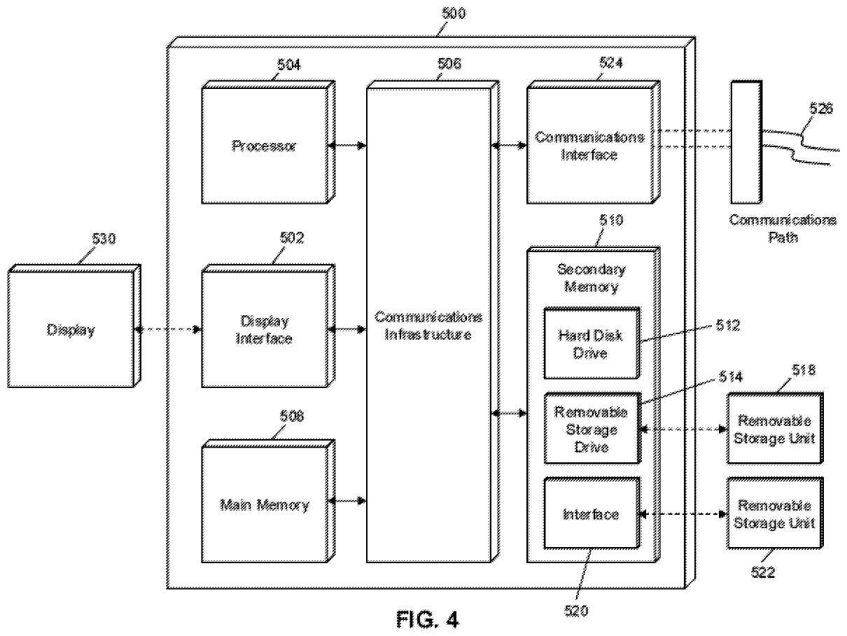

The processing server 102 includes, for example, a processor 104, a memory 108, a storage 110, a data access management and data entitlements integration program 120, an application programming interface (API) 122, an API 124, a data program 126, and a data program 128. The processing server 102 may be a desktop computer, a notebook, a laptop computer, a tablet computer, a handheld device, a smart-phone, a thin client, or any other electronic device or computing system capable of storing, compiling, and organizing audio, visual, or textual data and receiving and transmitting that data to and from other computing devices, such as the external data store 130, the external data store 140, and/or the user device 150. For example, the computer system 500 illustrated in FIG. 4 and discussed in more detail below may be a suitable configuration of the processing server 102. While only a single processing server 102 is illustrated, it can be appreciated that any number of processing servers 102 can be a part of the system 100.

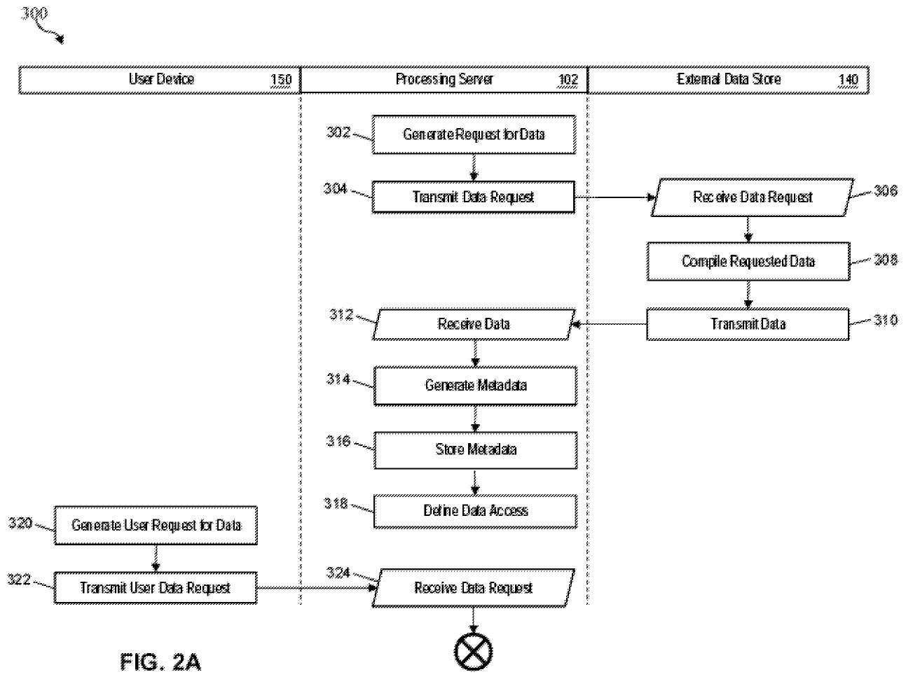

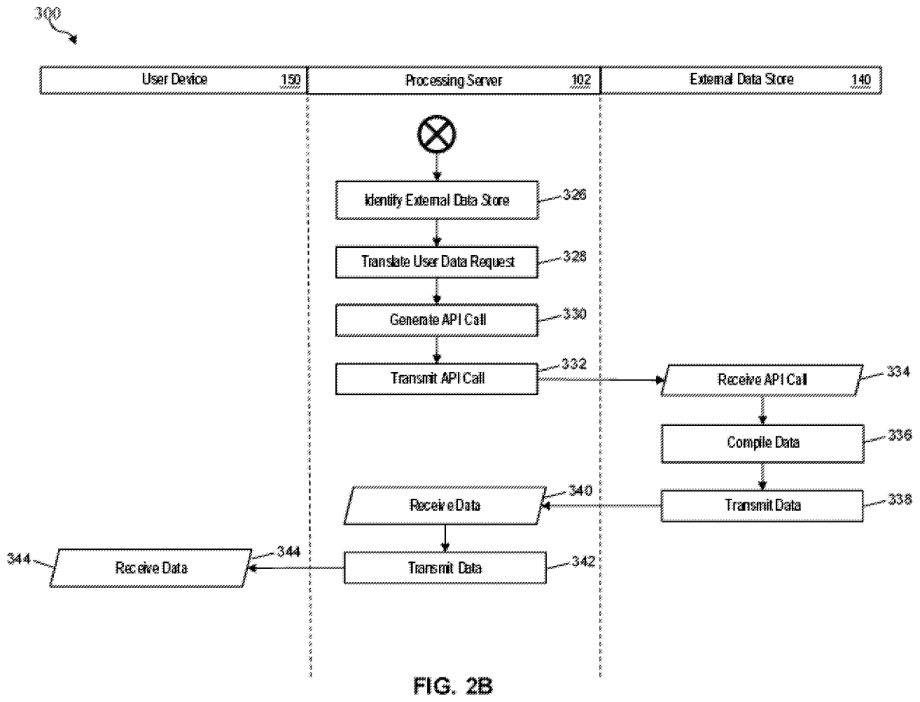

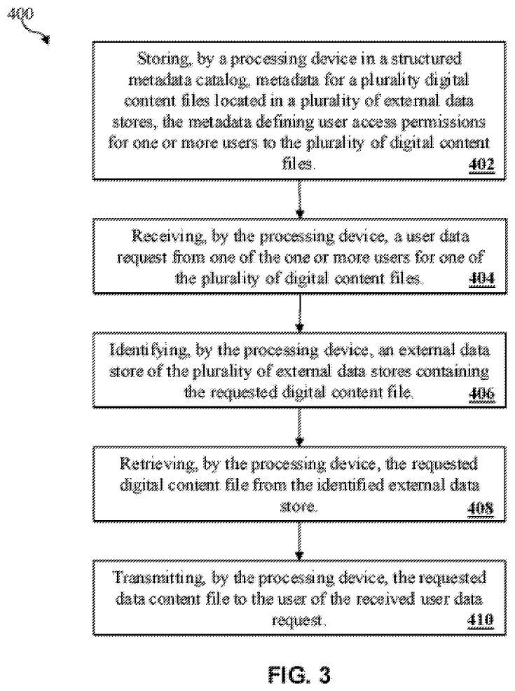

The processor 104 may include a graphics processing unit (GPU) 106. The processor 104 may be a special purpose or general purpose processor device specifically configured to perform the functions discussed herein. The processor 104 unit or device as discussed herein may be a single processor, a plurality of processors, or combinations thereof. Processor devices may have one or more processor “cores.” In an exemplary embodiment, the processor 104 is configured to perform the functions associated with the modules of the data access management and data entitlements integration program 120 as discussed below with reference to FIGS. 2A, 2B, and 3. The GPU 106 may be specially configured to perform the functions of the data access management and data entitlements integration program 120 discussed herein. For example, the GPU 106 is configured to process and/or generate graphics associated with the data 132, the data 142, the metadata 112, the data access management and data entitlements integration program 120, the API 122, the API 124, the data program 126, and/or the data program 128.

The memory 108 can be a random access memory, read-only memory, or any other known memory configurations. Further, the memory 108 can include one or more additional memories including the storage 110 in some embodiments. The memory 108 and the one or more additional memories can be read from and/or written to in a well-known manner. In an embodiment, the memory and the one or more additional memories can be non-transitory computer readable recording media. Memory semiconductors (e.g., DRAMs, etc.) can be means for providing software to the computing device such as the data access management and data entitlements integration program 120. Computer programs, e.g., computer control logic, can be stored in the memory 108.

The storage 110 can include, for example, metadata catalog 112, user profile database 114, and user group profile database 118. The storage 110 can be deployed on one or more nodes, e.g., storage or memory nodes, or one or more processing-capable nodes such as a server computer, desktop computer, notebook computer, laptop computer, tablet computer, handheld device, smart-phone, thin client, or any other electronic device or computing system capable of storing, compiling, and/or processing data and computer instructions (e.g., metadata catalog 112, user profile database 114, and user group profile database 118, data 132, data 142, etc.), and receiving and sending that data to and from other devices, such as the external data store 130, the external data store 140, and/or the user device 150. The storage 110 can be any suitable storage configuration, such as, but not limited to, a relational database, a structured query language (SQL) database, a distributed database, or an object database, etc. Suitable configurations and storage types will be apparent to persons having skill in the relevant art.

The metadata catalog 112 includes any metadata of the data 132 and/or the data 142. For example, the metadata catalog 112 includes, but is not limited to, descriptive metadata (e.g., a title, an abstract, an author, keywords, etc.), structural metadata (e.g., data container information and how objects within the data are arranged, etc.), administrative data (e.g., resource type, permissions, data creation data, data type, etc.), reference metadata (e.g., information about the contents and quality of statistical data, etc.), statistical metadata (e.g., processes that collect, process, or produce statistical data, etc.), and legal metadata (e.g., data creator information, copyright information, data licensing information, etc.), etc. For example, the data 132 may include a digital document file and the metadata catalog 112 includes metadata for that digital document file including, but not limited to, a document file type (e.g., .doc, .docx, .pdf, .htm, .html, .rtf, .txt, .xml, etc.), a document file author, a document file creation date, document modification information (e.g., changes and/or updates to the content of the document file, etc.), and access permissions for the document file, etc. In an exemplary embodiment, the metadata catalog 112 is a central metadata catalog that stores the metadata of the data 132 and/or the data 142 using a common metadata model. The common metadata models of the metadata catalog 112 can include, but is not limited to, groups (e.g., the one or more group profiles of the user group profile database 116), roles, users, permissions, resources, objects (e.g., of the data 132 and/or the data 142), data elements (e.g., of the data 132 and/or the data 142), etc.

The user profile database 114 includes one or more user profiles. The one or more user profiles includes user information about one or more users of the system 100. For example, the system 100 may be an internal computing system of a corporation and the one or more users may be employees of the corporation. The user information may include, but is not limited to, an employee name, an employee title, an employee identification number, an employee security access level, an employee group assignment, etc. The one or more user profiles may define a data access level for each of the one or more users of the system 100. For example, a user profile for a user of the user device 150 defines what data of the data 132 and the data 142, which that user may access. Each of the one or more user profiles of the user profile database 114 may identify one or more group profiles in the user group profile database 116 to which a user of a user profile is assigned to.

The user group profile database 116 includes one or more user group profiles. The one or more user group profiles define the one or more users of the system 100 into one or more groups. The one or more group profiles may be based on a company department type, an employee title, an employee team, etc. For example, the system 100 may be operated by a financial company and a group profile may be created for each department of the company (e.g., analysts, traders, customer service, sales, compliance, legal, etc.). As another example, there may be more than one group profile just for analysts based on seniority of the analysts (e.g., a group profile for analyst executives, a group profile for analyst mangers, and a group profile for analysts, etc.). The one or more group profiles of the group profile database 116 each include a security access level to data (e.g., the data 132 and/or the data 142, etc.) for the group defined by each of the one or more group profiles. For example, analysts may have access to certain data for analyzing and identifying entities for investment (e.g., company databases and records, etc.), but they may not have access to internal company information such as, but not limited to, employee data, internal financial data, etc. Each of the one or more group profiles of the group profile database 116 may identify a group manager or approver responsible for, but not limited to, approving and/or making additions to the group, removing people from the group, setting and/or managing data access levels for the group, approving and/or denying data requests received from people within the group, etc. For example, a user of the user device 150 may request a data file in the data 132 and the data access management and data entitlements integration program 120 may first generate a notice to the group manager or approver of the group profile to which the user of the user device 150 belongs. The group manager or approver of the group profile may approve or deny the data file request of the user of the user device 150.

The data access management and data entitlements integration program 120 is a software component that utilizes the data 132, the data 142, and/or the metadata 112 received from one or more of the external data store 130, 140 to generate the data output 154. In an exemplary embodiment, the data access management and data entitlements integration program 120 includes, a data collection module 202, a data processing module 204, a user access module 206, a user request processing module 208, a data retrieval module 210, and a data transmission module 210. The data access management and data entitlements integration program 120 is a software component specifically programmed to implement the methods and functions disclosed herein for processing, retrieving, and otherwise managing the data 132, 142, and managing the access to the data 132, 142. The data access management and data entitlements integration program 120 and the modules 202-210 are discussed in more detail below with reference to FIGS. 2A, 2B, and 3.

The data access management and data entitlements integration program 120 can include a graphical user interface 152. The graphical user interface 152 can include components used to receive input from the processing server 102, the external data store 130, the external data store 140, and/or the user device 150 and transmit the input to the data access management and data entitlements integration program 120 or conversely to receive information from the data access management and data entitlements integration program 120 and display the information on the processing server 102, and/or the user device 150. In an example embodiment, the graphical user interface 152 uses a combination of technologies and devices, such as device drivers, to provide a platform to enable users of the processing server 102, and/or the user device 150 to interact with the data access management and data entitlements integration program 120. In the example embodiment, the graphical user interface 152 receives input from a physical input device, such as a keyboard, mouse, touchpad, touchscreen, camera, microphone, etc. In an exemplary embodiment, the graphical user interface 152 may display the data output 154. While the graphical user interface 152 is illustrated as part of the user device 150, it can be appreciated that the graphical user interface 152 is a part of the data access management and data entitlements integration program 120 and may be a part of the processing server 102, and/or the user device 150.

While the processor 104, the memory 108, the storage 110, and the data access management and data entitlements integration program 120 are illustrated as part of the processing server 102, it can be appreciated that each of these elements or a combination thereof can be a part of a separate computing device.

The application programming interface (API) 122 is a software intermediary enabling communication between the data access management and data entitlements integration program 120 and the data program 126. The API 122 is a set of defined rules that processes data transfer between the data access management and data entitlements integration program 120 and the data program 126. For example, the data access management and data entitlements integration program 120 may utilize the API 122 to translate a user data request for the data 132 into a native language API call to the external data store 130 associated with the data program 126 and storing the data 132. The data program 126 may be any program, application, or website, etc. that generates, stores, or otherwise contains data (e.g., the data 132), which users of the system 100 need access to. The data program 126 may store its associated data (e.g., the data 132) in the external data store 130.

The external data store 130 can include, for example, the data 132. The external data store 130 can be deployed on one or more nodes, e.g., storage or memory nodes, or one or more processing-capable nodes such as a server computer, desktop computer, notebook computer, laptop computer, tablet computer, handheld device, smart-phone, thin client, or any other electronic device or computing system capable of storing, compiling, and/or processing data and computer instructions (e.g., the data 132) and receiving and sending that data to and from other devices, such as the external data store 130, the processing server 102, and/or the user device 150. The data 132 may be any data generated, stored, and/or required by one or more users of the system 100. For example, but not limited to, the data 132 may be data generated by one or more users of the system 100 or the data 132 may be data generated by third-party systems that the user of the system 100 need access to. The data 132 may include, but is not limited to, document files (e.g., PDF, DOC, DOCX, HTML, HTM, XLS, XLSX, TXT files, etc.), image files (e.g., JPG, JPEG, GIF, SVG, PNG, TIFF, TIF files, etc.), video files (MP4, AVI, MOV, FLV, AVCHD files, etc.), presentation files (e.g., PPT, PPTX, ODP, KEY files, etc.), audio files (M44, MP3, WAV files, etc.), etc. The data files of the data 132 each include metadata such as, but not limited to, descriptive metadata (e.g., a title, an abstract, an author, keywords, etc.), structural metadata (e.g., data container information and how objects within the data are arranged, etc.), administrative data (e.g., resource type, permissions, data creation data, data type, etc.), reference metadata (e.g., information about the contents and quality of statistical data, etc.), statistical metadata (e.g., processes that collect, process, or produce statistical data, etc.), and legal metadata (e.g., data creator information, copyright information, data licensing information, etc.), etc. The external data store 130 can be any suitable storage configuration, such as, but not limited to, a relational database, a structured query language (SQL) database, a distributed database, or an object database, etc. Suitable configurations and storage types will be apparent to persons having skill in the relevant art. In an exemplary embodiment, the external data store 130 is associated with one or more of the data programs on the processing server 102 (e.g., the data program 126, and/or the data program 128, etc.).

The application programming interface (API) 124 is a software intermediary enabling communication between the data access management and data entitlements integration program 120 and the data program 128. The API 124 is a set of defined rules that processes data transfer between the data access management and data entitlements integration program 120 and the data program 128. For example, the data access management and data entitlements integration program 120 may utilize the API 124 to translate a user data request for the data 142 into a native language API call to the external data store 140 associated with the data program 128 and storing the data 142. The data program 128 may be any program, application, or website, etc. that generates, stores, or otherwise contains data (e.g., the data 142), which users of the system 100 need access to. The data program 128 may store its associated data (e.g., the data 142) in the external data store 140.

The external data store 140 can include, for example, the data 132. The external data store 140 can be deployed on one or more nodes, e.g., storage or memory nodes, or one or more processing-capable nodes such as a server computer, desktop computer, notebook computer, laptop computer, tablet computer, handheld device, smart-phone, thin client, or any other electronic device or computing system capable of storing, compiling, and/or processing data and computer instructions (e.g., the data 142) and receiving and sending that data to and from other devices, such as the external data store 140, the processing server 102, and/or the user device 150. The data 142 may be any data generated, stored, and/or required by one or more users of the system 100. For example, but not limited to, the data 142 may be data generated by one or more users of the system 100 or the data 142 may be data generated by third-party systems that the user of the system 100 need access to. The data 142 may include, but is not limited to, document files (e.g., PDF, DOC, DOCX, HTML, HTM, XLS, XLSX, TXT files, etc.), image files (e.g., JPG, JPEG, GIF, SVG, PNG, TIFF, TIF files, etc.), video files (MP4, AVI, MOV, FLV, AVCHD files, etc.), presentation files (e.g., PPT, PPTX, ODP, KEY files, etc.), audio files (M44, MP3, WAV files, etc.), etc. The data files of the data 142 each include metadata such as, but not limited to, descriptive metadata (e.g., a title, an abstract, an author, keywords, etc.), structural metadata (e.g., data container information and how objects within the data are arranged, etc.), administrative data (e.g., resource type, permissions, data creation data, data type, etc.), reference metadata (e.g., information about the contents and quality of statistical data, etc.), statistical metadata (e.g., processes that collect, process, or produce statistical data, etc.), and legal metadata (e.g., data creator information, copyright information, data licensing information, etc.), etc. The external data store 140 can be any suitable storage configuration, such as, but not limited to, a relational database, a structured query language (SQL) database, a distributed database, or an object database, etc. Suitable configurations and storage types will be apparent to persons having skill in the relevant art. In an exemplary embodiment, the external data store 140 is associated with one or more of the data programs on the processing server 102 (e.g., the data program 126, and/or the data program 128, etc.).

While two APIs (e.g., the API 122 and the API 124), two data programs (e.g., the data program 126 and the data program 128), and two external data stores (e.g., the external data store 130 and the external data store 140) are illustrated as a part of the system 100, it can be appreciated that any number of APIs, data programs, and external data stores can be a part of the system 100 including less than two or more than two.

The user device 150 may be a desktop computer, a notebook, a laptop computer, a tablet computer, a handheld device, a smart-phone, a thin client, or any other electronic device or computing system capable of storing, compiling, and organizing audio, visual, or textual data and receiving and transmitting that data to and from other computing devices, such as the processing server 102, the external data store 130, and/or the external data store 140. For example, the computer system 500 illustrated in FIG. 4 and discussed in more detail below may be a suitable configuration of the user device 150. In an exemplary embodiment, the user device 150 transmits a user data request (e.g., for a data file stored in the data 132 and/or the data 142) to the processing server 102 and receives the requested data file (e.g., the data output 154) from the processing server 102. The user device 150 may include a display 156 which can include the graphical user interface 152. The display 156 be any electronic device or computing system capable of receiving display signals from the user device 150, and/or another computing device, such as the processing server 102, the external data store 130, and/or the external data store 140, etc. and outputting those display signals to a display unit such as, but not limited to, an LCD screen, plasma screen, LED screen, DLP screen, CRT screen, etc. The display 156 may communicate with the processing server 102, the external data store 130, and/or the external data store 140 via a hard-wired connection or via the network 160. For example, the display 156 may have a hard-wired connection to the image device such as, but not limited to, a USB connection, an HDMI connection, a display port connection, a VGA connection, or any other known hard-wired connection capable of transmitting and/or receiving data between the processing server 102, the external data store 130, the data store 140, and/or the user device 150. While only a single user device 150 is illustrated in FIG. 1A, it can be appreciated that any number of user devices 150 may be a part of the system 100.

The optional network 160 may be any network suitable for performing the functions as disclosed herein and may include a local area network (LAN), a wide area network (WAN), a wireless network (e.g., WiFi), a personal area network (PAN) (e.g. Bluetooth), a near-field communication (NFC) network, a mobile communication network, a satellite network, the Internet, fiber optic, coaxial cable, other hardwired networks, infrared, radio frequency (RF), or any combination of the foregoing. Other suitable network types and configurations will be apparent to persons having skill in the relevant art. In general, the network 160 can be any combination of connections and protocols that will support communications between the processing server 102, the external data store 130, the external data store 140, and/or the user device 150. In some embodiments, the network 160 may be optional based on the configuration of the processing server 102, the external data store 130, the external data store 140, and/or the user device 150.

Exemplary Process for Data Access Management and Data Entitlements Integration

FIGS. 2A-2B illustrates a process 300 for data access management and data entitlements integration in the system 100 of FIG. 1A.

In step 302, the processing server 102 generates a request for data 142 from the external data store 140. The processing server 102 may generate a request for all data 142 or for one or more individual files contained within the data 142. The processing server 102 may generate a request for data (e.g., the data 132, the data 142, etc.) from one or more external data stores (e.g., the external data store 130 and/or the external data store 140, etc.). The request for the data 142 may be generated automatically by the data access management and data entitlements integration program 120 or generated by user input via the graphical user interface 152. In an exemplary embodiment, the data collection module 202 of the data access management and data entitlements integration program 120 can be configured to execute step 302.

In step 304, the processing server 102 transmits the request for the data 142 to the external data store 140. The request may be transmitted to the external data store 140 using any suitable communication method (e.g., the network 160). The request for the data 142 may be transmitted to the external data store 140 via the API 124. For example, the data 142 stored in the external data store 140 may be associated with the data program 128 and the data access management and data entitlements integration program 120 may generate an API call to the external data store 140 via the API 124. In an exemplary embodiment, the data collection module 202 of the data access management and data entitlements integration program 120 can be configured to execute step 304.

In step 306, the external data store 140 receives the request for the data 142 from the processing server 102 and in step 308, the external data store 140 compiles the requested data 142. The external data store 140 may search a local or remote database for the data 142 or in turn may submit a request to a third computing device for the data 142. The external data store 140 transmits the data 142 to the processing server 102 in step 310. The data 142 may be transmitted to the processing server 102 using any suitable communication method (e.g., the network 160).

In step 312, the processing server 102 receives the data 142 from the external data store 140. The processing server 102 may temporarily store the data 142 in the storage 110 for processing. In an exemplary embodiment, the data collection module 202 of the data access management and data entitlements integration program 120 can be configured to execute step 312.

In step 314, the processing server generates metadata from the data 142 and stores the metadata in the metadata catalog 112. The metadata of the data 142 includes, but is not limited to, descriptive metadata (e.g., a title, an abstract, an author, keywords, etc.), structural metadata (e.g., data container information and how objects within the data are arranged, etc.), administrative data (e.g., resource type, permissions, data creation data, data type, etc.), reference metadata (e.g., information about the contents and quality of statistical data, etc.), statistical metadata (e.g., processes that collect, process, or produce statistical data, etc.), and legal metadata (e.g., data creator information, copyright information, data licensing information, etc.), etc. For example, the data 142 may include a digital document file and the metadata for that digital document file includes, but not limited to, a document file type (e.g., .doc, .docx, .pdf, .htm, .html, .rtf, .txt, .xml, etc.), a document file author, a document file creation date, document modification information (e.g., changes and/or updates to the content of the document file, etc.), and access permissions for the document file, etc. The processing server 102 stores the metadata of the data 142 in the metadata catalog 112 at step 316. In an exemplary embodiment, the data processing module 204 of the data access management and data entitlements integration program 120 can be configured to execute steps 314-316.

In step 318, data access by the users of the system 100 access to the data 142 may be defined in the metadata of the data 142 stored in the metadata catalog 112. User access to the data 142 may be defined by an administrator of the system 100 via the graphical user interface 152 or automatically by the data entitlements integration program 120. In an exemplary embodiment, the user access module 206 of the data access management and data entitlements integration program 120 can be configured to execute step 318.

In step 320, the user device 150 generates a user data request for one or more digital files (e.g., one or more digital files contained in the data 142) stored in one or more external data stores (e.g., the external data store 130, the external data store 140, etc.). For example, an analyst may submit a request for an investment report fora specific entity stored in the external data store 140.

In step 322, the user device 150 transmits the user data request to the processing server 102. The user data request may be transmitted to the processing server 102 using any suitable communication method (e.g., the network 160).

In step 324, the processing server 102 receives the user data request from the user device 150. In an embodiment the processing server may process the user data request. Processing the user data request can include identifying, by the processing server 102, an approver for a group of the user of the received user data request. For example, the user data request may be received from a user belonging to a user group profile stored in the user group profile database 116 and the processing server 102 may identify the approver for that particular user group profile. The processing server 102 may generate a notice of the user data request to the identified approver of the user group profile and transmit the notice to the approver. In response to receiving approval for the user to access the data in the received user data request, the processing server 102 may proceed to step 326. If the approver denies the user data request, the processing server may notify the user of the user device 150 of the denial and the process 300 terminates. In an exemplary embodiment, the user request processing module 208 of the data access management and data entitlements integration program 120 can be configured to execute step 324.

In step 326 the processing device 102 identifies an external data store (e.g., the external data store 140) of a plurality of external data stores containing the requested digital content file. In an exemplary embodiment, the data retrieval module 210 of the data access management and data entitlements integration program 120 can be configured to execute step 326.

In step 328 the processing server 102 translates the user data request into a native language of the identified external data store (e.g., the external data store 140). For example, the processing server 102 translates the user data request into a native language of the data program 128 associated with the external data file 140. In an embodiment, the data program 128 may be a data platform service that stores the data 142 in the external data store 140 and the processing server 102 may translate the user data request in a standardized query language (SQL) programming language of the data program 128. In an exemplary embodiment, the data retrieval module 210 of the data access management and data entitlements integration program 120 can be configured to execute step 328.

In step 330, the processing server 102 generates an application programming interface (API) call (e.g. via the API 124) to the identified external data store (e.g., the external data store 140). The API call includes the metadata for the user (e.g., the data access level) of the received user data request. In an exemplary embodiment, the data retrieval module 210 of the data access management and data entitlements integration program 120 can be configured to execute step 330. The processing server 102 transmits the API call to the identified external data store (e.g., the external data store 140) in step 332. For example, the processing server 102 may transmit the API call via the API 124. In an exemplary embodiment, the data retrieval module 210 of the data access management and data entitlements integration program 120 can be configured to execute step 330.

In step 334, the external data store 140 receives the API call from the processing server 102 and compiles the requested data (e.g., a data file stored in the data 142) in step 336. The external data store 140 transmits the requested data to the processing server 102 in step 338. The external data store 140 may transmit the requested data to the processing server 102 using any suitable communication method (e.g., the network 160).

In step 340, the processing server 102 receives the requested data file from the identified external data store (e.g., the external data store 140) and transmits the requested data file to the user of the received user data request (e.g., the user device 150). The processing server 102 may transmit the requested data to the user device 150 using any suitable communication method (e.g., the network 160). In step 342, the user device 150 receives the requested data file from the processing server 102.

Exemplary Method for Data Access Management and Data Entitlements Integration

FIG. 3 illustrates a method 400 for data access management and data entitlements integration in accordance with exemplary embodiments.

The method 400 can include block 402 of storing, by a processing device (e.g., the processing server 102) in a structured metadata catalog (e.g., the storage 110), metadata (e.g., the metadata 112) for a plurality digital content files (e.g., the data 132, the data 142, etc.) located in a plurality of external data stores (e.g., the external data store 130, the external data store 140, etc.). The metadata defines user access permissions for one or more users to the plurality of digital content files. The one or more users are defined into one or more user groups with each group including, but not limited to, an approver designated for approving user data requests. The user access permissions of each of the one or more users may be based on the group of each of the one or more users. In an exemplary embodiment, data collection module 202 of the data access management and data entitlements integration program 120 can be configured to execute the method of block 402. The processing server 102 may update by performing, but not limited to, one or more of: adding a new user to the one or more groups; changing user access permissions for one or more of the one or more users; changing the user group of one or more of the one or more users; and adding new metadata for one or more new digital content files. The processing server 102 may generate an alert of the update to the structured metadata catalog and transmit the alert to a system administrator of the structured metadata catalog. In an exemplary embodiment, user access module 206 of the data access management and data entitlements integration program 120 can be configured to execute the updating of the structured metadata catalog, generating an update alert, and transmit that update alert.

The method 400 can include block 404 of receiving, by the processing device (e.g., the processing server 102), a user data request from one of the one or more users (e.g., from the user device 150) for one of the plurality of digital content files (e.g., the data 132, the data 142, etc.). In an exemplary embodiment, user request processing module 208 of the data access management and data entitlements integration program 120 can be configured to execute the method of block 404.

The method 400 can include block 406 of identifying, by the processing device (e.g., the processing server 102), an external data store (e.g., the external data store 140 or the external data store 150) of the plurality of external data stores containing the requested digital content file. In an exemplary embodiment, user request processing module 208 of the data access management and data entitlements integration program 120 can be configured to execute the method of block 406.

The method 400 can include block 408 of retrieving, by the processing device (e.g., the processing server 102), the requested digital content file from the identified external data store (e.g., the external data store 140 or the external data store 150). Retrieving the requested digital content file may include: translating the user data request into a native language of the identified external data store; generating an application programming interface (API) call, the API call including the metadata for the user of the received user data request, to the identified external data store; transmitting the API call to the identified external data store; and receiving the requested digital content file from the identified external data store. Retrieving the requested digital content file by the processing device may include: identifying the approver for the group of the user of the received user data request; generating a notice of the user data request to the approver; transmitting the notice to the approver; and receiving approval of the user data request. In an exemplary embodiment, data retrieval module 210 of the data access management and data entitlements integration program 120 can be configured to execute the method of block 408.

The method 400 can include block 410 of transmitting, by the processing device (e.g., the processing server 102), the requested data content file to the user of the received user data request. In an exemplary embodiment, data transmission module 212 of the data access management and data entitlements integration program 120 can be configured to execute the method of block 410.

### Computer System Architecture

FIG. 4 illustrates a computer system 500 in which embodiments of the present disclosure, or portions thereof, may be implemented as computer-readable code. For example, the processing server 102, the external data store 130, the external data store 140, and/or the user device 150 of FIGS. 1A-1B may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 2A, 2B, and 3.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the processes and methods illustrated by FIGS. 2A, 2B, and 3, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 400 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for data access management and data entitlements integration. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter. It will be appreciated by those skilled in the art that the present disclosure can be embodied in other specific forms without departing from the spirit or essential characteristics thereof. The presently disclosed embodiments are therefore considered in all respects to be illustrative and not restrictive. The scope of the disclosure is indicated by the appended claims rather than the foregoing description, and all changes that come within the meaning, range, and equivalence thereof are intended to be embraced therein.

What is claimed is:

1. A method for data access management, the method comprising:
storing, by a processing device in a structured metadata catalog, metadata for a plurality digital content files located in a plurality of external data stores, the metadata defining user access permissions for one or more users to the plurality of digital content files;
receiving, by the processing device, a user data request from one of the one or more users for one of the plurality of digital content files;
identifying, by the processing device, an external data store of the plurality of external data stores containing the requested digital content file; and
retrieving, by the processing device, the requested digital content file from the identified external data store, wherein the retrieving the requested digital content file includes:
translating, by the processing device, the user data request into a native language of the identified external data store;
generating, by the processing device, an application programming interface (API) call to the identified external data store, the API call including the metadata for the user of the received user data request;
transmitting, by the processing device, the API call to the identified external data store;
receiving, by the processing device, the requested digital content file from the identified external data store; and
transmitting, by the processing device, the requested data content file to the user of the received user data request.

2. The method of claim 1, wherein the one or more users are defined into one or more user groups, each of the one or more user groups including an approver designated for approving user data requests.

3. The method of claim 2, wherein the retrieving requested digital content file includes:
identifying, by the processing device, the approver for the group of the user of the received user data request;
generating, by the processing device, a notice of the user data request to the approver;
transmitting, by the processing device, the notice to the approver; and
receiving, by the processing device, approval of the user data request.

4. The method of claim 2, wherein the user access permissions of each of the one or more users is based on the group of each of the one or more users.

5. The method of claim 2, comprising:
updating, by the processing device, the structured metadata catalog, wherein updating the structured metadata catalog includes one or more of:
adding, by the processing device, a new user to the one or more groups;
changing, by the processing device, user access permissions for one or more of the one or more users;
changing, by the processing device, the user group of one or more of the one or more users; and
adding, by the processing device, new metadata for one or more new digital content files.

6. The method of claim 5, wherein the updating the structured metadata catalog includes:
generating, by the processing device, an alert of the update to the structured metadata catalog; and
transmitting, by the processing device, the alert to a system administrator of the structured metadata catalog.

7. A system for data access management, the system comprising:
one or more processors, one or more computer-readable memories, one or more computer-readable tangible storage devices, and instructions stored on at least one of the one or more storage devices for execution by at least one of the one or more processors via at least one of the one or more computer-readable memories, the instructions comprising:
instructions to store in a structured metadata catalog, metadata for a plurality digital content files located in a plurality of external data stores, the metadata defining user access permissions for one or more users to the plurality of digital content files;
instructions to receive a user data request from one of the one or more users for one of the plurality of digital content files;
instructions to identify an external data store of the plurality of external data stores containing the requested digital content file; and
instructions to retrieve the requested digital content file from the identified external data store, wherein the retrieving the requested digital content file includes:
instructions to translate the user data request into a native language of the identified external data store;
instructions to generate an application programming interface (API) call to the identified external data store, the API call including the metadata for the user of the received user data request;
instructions to transmit the API call to the identified external data store;
instructions to receive the requested digital content file from the identified external data store; and
instructions to transmit the requested data content file to the user of the received user data request.

8. The system of claim 7, wherein the one or more users are defined into one or more user groups, each of the one or more user groups including an approver designated for approving user data requests.

9. The system of claim 8, wherein the instructions to retrieve requested digital content file includes:
instructions to identify the approver for the group of the user of the received user data request;
instructions to generate a notice of the user data request to the approver;
instructions to transmit the notice to the approver; and
instructions to receive approval of the user data request.

10. The system of claim 8, wherein the user access permissions of each of the one or more users is based on the group of each of the one or more users.

11. The system of claim 8, comprising:
instructions to update the structured metadata catalog data, wherein updating the structured metadata catalog includes one or more of:
adding, by the processing device, a new user to the one or more groups;
changing, by the processing device, user access permissions for one or more of the one or more users;
changing, by the processing device, the user group of one or more of the one or more users; and
adding, by the processing device, new metadata for one or more new digital content files.

12. The system of claim 11, wherein the instructions to update the structured metadata catalog includes:
instructions to generate an alert of the update to the structured metadata catalog; and
instructions to transmit the alert to a system administrator of the structured metadata catalog.

13. A computer program product for data access management, the computer program product comprising:
a computer-readable storage medium having program instructions embodied therewith, the program instructions executable by a computer to cause the computer to perform a method, comprising:
storing, by a processing device in a structured metadata catalog, metadata for a plurality digital content files located in a plurality of external data stores, the metadata defining user access permissions for one or more users to the plurality of digital content files;
receiving, by the processing device, a user data request from one of the one or more users for one of the plurality of digital content files;
identifying, by the processing device, an external data store of the plurality of external data stores containing the requested digital content file; and
retrieving, by the processing device, the requested digital content file from the identified external data store, wherein the retrieving the requested digital content file includes:
translating, by the processing device, the user data request into a native language of the identified external data store;
generating, by the processing device, an application programming interface (API) call to the identified external data store, the API call including the metadata for the user of the received user data request;
transmitting, by the processing device, the API call to the identified external data store;
receiving, by the processing device, the requested digital content file from the identified external data store; and
transmitting, by the processing device, the requested data content file to the user of the received user data request.

14. The computer program product of claim 13, wherein the one or more users are defined into one or more user groups, each of the one or more user groups including an approver designated for approving user data requests.

15. The computer program product of claim 14, wherein the retrieving the requested digital content file includes:
identifying, by the processing device, the approver for the group of the user of the received user data request;
generating, by the processing device, a notice of the user data request to the approver;
transmitting, by the processing device, the notice to the approver; and
receiving, by the processing device, approval of the user data request.

16. The computer program product of claim 14, wherein the user access permissions of each of the one or more users is based on the group of each of the one or more users.

17. The computer program product of claim 14, comprising:
updating, by the processing device, the structured metadata catalog, wherein updating the structured metadata catalog includes one or more of:
adding, by the processing device, a new user to the one or more groups;
changing, by the processing device, user access permissions for one or more of the one or more users;
changing, by the processing device, the user group of one or more of the one or more users; and
adding, by the processing device, new metadata for one or more new digital content files.

18. The computer program product of claim 17, wherein the updating the structured metadata catalog includes:
generating, by the processing device, an alert of the update to the structured metadata catalog; and
transmitting, by the processing device, the alert to a system administrator of the structured metadata catalog.
